(19) United States
(12) Patent Application Publication
(10) Pub. No.: US 2024/0217702 A1
(43) Pub. Date: Jul. 4, 2024

(54) COATED CONTAINERS AND METHODS OF FORMING SUCH CONTAINERS

(71) Applicant: Rohm and Haas Electronic Materials LLC, Mariborough, MA (US)

(72) Inventor: Sean Muir, Marlborough, MA (US)

(21) Appl. No.: 18/107,132

(22) Filed: Feb. 8, 2023

Related U.S. Application Data
(60) Provisional application No. 63/436,284, filed on Dec. 30, 2022.

(51) Int. Cl. B65D 23/02; B65D 65/42; B65D 85/84

(52) U.S. Cl. CPC B65D 23/02; B65D 65/42; B65D 85/84

(57) ABSTRACT

Disclosed herein is a container comprising an enclosure having an outer surface and an inner surface; and a polydopamine coating that is optionally derivatized disposed on an inner surface of the enclosure. Disclosed herein too is a method of coating a container, comprising (a) providing a container comprising an enclosure having an outer surface and an inner surface; and (b) disposing a solution comprising dopamine hydrochloride, a buffer and a solvent in the container.

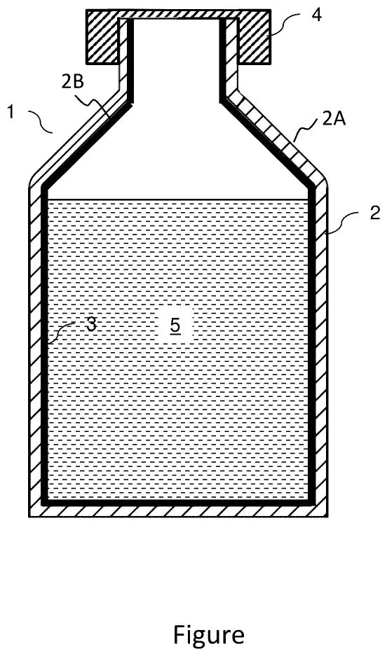

### BACKGROUND

This disclosure relates generally to containers for high-purity materials. More specifically, this disclosure relates to coating containers for storing high-purity materials and to methods of making such coated containers. The disclosure finds particular applicability in the packaging and storage of materials used in the manufacture of electronic devices (electronic materials) and, in particular, the semiconductor manufacturing industry, as well as in the water, food and pharmaceuticals industries.

In the semiconductor manufacturing industry, process chemicals comprising liquids are used throughout the manufacturing process, for example, in lithography, coating, cleaning, stripping, etching and chemical mechanical planarization (CMP) processes. Such chemicals include, for example, acids, solvents, photoresists, antireflective materials, developers, removers, slurries and cleaning solutions. With continued reductions in critical dimensions required for advanced semiconductor devices, it has become increasingly important that the process chemicals be provided in ultrapure form. However, process chemicals even in purified form typically contain trace amounts of metals such as iron, sodium, nickel, copper, calcium, magnesium and potassium, among others. The presence of metals in the process chemicals can be detrimental, resulting, for example, in patterning defects and alteration of electrical properties of the formed devices, thereby impacting device reliability and product yield. The source of such metal impurities can be from raw materials used in the chemical manufacturing process or may otherwise be introduced during the manufacturing and packaging processes.

The reduction of metals and other impurities from process chemicals, raw materials and precursors has conventionally been achieved through the use of ion-exchange and/or filtration processes. Following such purification, the chemicals are typically packaged in containers, for example, bottles or other vessels, which are then shipped to and stored by the end user. In the semiconductor manufacturing industry, the chemical containers are often plumbed directly to the process tools used for wafer processing to reduce the likelihood of contamination of the chemicals. It has been found, however, that the chemical containers themselves can be a source for impurities which may be generated in-situ during storage and transportation. Movement of the container such as during transport is believed to exacerbate this problem. In an effort to reduce particle generation in process chemicals, the use of bottles containing a fluorinated liner has been proposed, for example, in U.S. Patent Application Pub. No. 2013/0193164 A1. Avoidance of fluorine-containing materials, however, would be desired for environmental reasons. Moreover, such liners are passive materials and, at best, would not contribute to the total metals in the formulation. It would be desirable to provide a container which, beyond not contributing to total metals in the container material, actively removes such impurities from the contained chemicals. In addition to the electronics industry, such a container would be desirable for use, for example, in the water, food and pharmaceutical industries.

Accordingly, there is a need in the art for improved containers and their methods of making and use, which address one or more problems associated with the state of the art.

### SUMMARY

Disclosed herein is a container comprising an enclosure having an outer surface and an inner surface; and a polydopamine coating that is optionally derivatized disposed on an inner surface of the enclosure.

Disclosed herein too is a method of coating a container, comprising (a) providing a container comprising an enclosure having an outer surface and an inner surface; and (b) disposing a solution comprising dopamine hydrochloride, a buffer and a solvent in the container.

### BRIEF DESCRIPTION OF THE FIGURES

The FIGURE depicts an exemplary embodiment of the container that has a polydopamine coating disposed on its inner surface.

### DETAILED DESCRIPTION

The terminology used herein is for the purpose of describing particular embodiments only and is not intended to be limiting of the invention. The singular forms “a”, “an” and “the” are intended to include singular and plural forms, unless the context indicates otherwise.

Auto-polymerization is termed the process whereby monomers form large-chain molecules (i.e., polymers) without the need for a chemical initiator. In this case, dissolved oxygen in the solvent is thought to play a role similar to an initiator in the polymerization process. The process may be accelerated by the addition of a chemical oxidant, which may lead to improved coating.

Disclosed herein is a container that has a polydopamine coating or a polydopamine derivative coating on its inner surface. The polydopamine or its derivatives form a stable coating on an inner surface of the container. They can exhibit metal removal properties from contents that are stored in the container. These contents can include, for example, acids, solvents, polymers, photoresists, antireflective materials, developers, removers, slurries and cleaning solutions. In addition, the polydopamine can prevent leaching of metals from the container by passivating the surface. The polydopamine may be coated on a wide variety of surfaces including glass, metal, and inorganic or organic polymers using a simple solution-based method.

Disclosed herein too is a method of coating an inner surface of a container with a layer of polydopamine, optionally with a step of derivatizing the polydopamine layer. The method comprises dissolving a dopamine-containing monomer and a buffer in solvent to form a reactive solution that is then added to the container to be coated. The buffer facilitates the polymerization of the dopamine-containing monomer to form polydopamine. The reaction to form the polydopamine may be conducted in the container itself or in a reactor (separate from the container) and then poured into the container. The reactants (the dopamine-containing monomer and the buffer) along with the solvent are preferably added directly to the container where they undergo a reaction to form the polydopamine coating. It is preferred that the container with reactants inside is gently agitated when forming the coating to help achieve homogeneous reaction and coating on the inner surface of the container. The coated container is typically then washed with water to remove any loose polydopamine residue or contaminants left over from the coating process.

The container comprises an enclosure and optionally an article at least partially within the enclosure. The FIGURE depicts an exemplary embodiment of the container 1 with the polydopamine coating disposed on an inner surface of the container. The container 1 comprises an enclosure 2 that defines the outer boundaries of the container. The enclosure 2 has an outer surface 2A and an inner surface 2B. The container 1 typically has a cap 4 for sealing the enclosure 2 from the ambient atmosphere. In short, the container 1 is capable of being exposed to the ambient atmosphere or hermetically sealed off from it by the cap 4 (also termed a lid). The cap 4 typically prevents the loss of container contents due to evaporation and spillage. The inner surface 2B of the enclosure 2 is coated with the polydopamine coating 3. The container 1 may be used to store chemical compositions 5 from which metal impurities can be removed by the polydopamine coating during the period of storage.

The containers with the coating disposed thereon are effective for removing metal impurities from chemical compositions contained within the containers. Suitable containers include, for example, those used in the storage of high-purity chemicals useful in the electronics industry (electronic materials). Such chemicals include, for example, acids, solvents, polymers, photoresists, antireflective materials, developers, removers, slurries and cleaning solutions. The containers find further use, for example, in the water, pharmaceutical, and food industries. The containers can take various forms, for example, bottles, cans, boxes, drums and tanks. Suitable containers further include those of tank cars such as those used for the transportation of materials.

In an embodiment, the container contains a chemical composition in contact with the polydopamine coating. Preferably, the chemical composition is an electronic material. The chemical composition typically comprises an organic solvent. Also, preferably, the chemical composition is a high-purity or ultrapure chemical composition. The term “high-purity” means no more than 1 part per billion (ppb) of each individual metal specie contaminants. The term “ultrapure” means no more than 100 parts per trillion (ppt) of each individual metal specie contaminants. Preferably, the chemical composition contains metal contaminants in a total amount of less than 10 ppb, less than 5 ppb, less than 1 ppt, less than 0.5 ppt, or less than 0.1 ppt.

The container can comprise a metal, a glass, a polymer, or a combination thereof. Suitable metals include copper, tin, steel, brass, aluminum, and the like, or a combination thereof. Suitable glasses include silica, alumina, titania, zirconia, quartz, and the like, or a combination thereof.

The polymer materials are preferably thermoplastic, non-aromatic, hydrocarbon polymers which have a linear carbon-to-carbon backbone molecular structure with only non-aromatic substituents and have a plurality of free hydrogen atoms attached to the carbon atoms of the polymer chain. These polymers can be blown or molded to form the containers. Examples of these thermoplastic extrusion grade or moldable grade hydrocarbon polymers are homopolymers of ethylene, propylene, isobutylene, methyl-pentene-1, butene-1, vinyl chloride, vinylidene chloride, acrylonitrile, interpolymers of the foregoing monomers with each other, chlorinated polyethylene and chlorinated polypropylene, fluoropolymers such as, for example, polytetrafluoroethylene, perfluoroalkoxy polymers; polycarbonates, polyesters, polystyrene, and blends of the foregoing monomers and copolymers. Of particular interest are the high and low density polyethylene, polypropylene, ethylene/propylene copolymers, ethylene/1-butene copolymers and blends thereof.

The polymer composition used for manufacturing the container can include one or more optional additives chosen, for example, from antioxidants, pigments, dyes or extenders known in the art. Such optional additives if used are typically present in the composition in minor amounts such as from 0.01 to 10 wt % based on total solids of the polymer composition.

As noted above, the dopamine-containing monomer is polymerized in solution using a buffer. The dopamine-containing monomer, the buffer, the solvent and any additional components are added to the container (that is to be coated) or to a reactor (that is not the container to be coated) to form a reactive solution. The dopamine-containing monomer undergoes auto-polymerization to form polydopamine.

The dopamine-containing monomer is typically in the form of a salt. In such case, the dopamine preferably exists in its protonated form with a halide counterion, for example, a Cl⁻, Br⁻, F⁻ or I⁻ counterion. In a preferred embodiment, the dopamine-containing monomer is dopamine hydrochloride. The dopamine-containing monomer is typically present in the reactive solution in an amount of 0.01 to 10 weight percent (wt %) based on the total weight of the reactive solution. The dopamine-containing monomer is preferably present in the reactive solution in an amount of 0.02 to 5 wt %, from 0.02 to 1 wt %, or from 0.05 to 0.20 wt % based on the total weight of the reactive solution.

The buffer is primarily used to adjust the pH of the solution to be in a range that facilitates auto-polymerization of the dopamine-containing monomer. The buffer preferably has a pKa between 7.0 and 9.0.

Examples of the buffer include tris buffer (tris(hydroxymethyl)aminomethane), sodium dihydrogen phosphate, potassium dihydrogen phosphate, or a combination thereof.

The buffer is typically present in the reactive solution in an amount of 0.01 to 5 wt % based on the total weight of the reactive solution. The buffer is preferably present in the reactive solution in an amount of 0.01 to 3 wt %, 0.05 to 1 wt %, or 0.10 to 0.30 wt % based on the total weight of the reactive solution.

The solvent present in the reactive solution should be capable of dissolving the dopamine-containing monomers and any other solid components of the solution. The solvent forms the balance of the reactive solution. Examples of suitable solvents are water, organic solvents such as an alcohol, or a combination thereof. Particularly preferred solvents include ethanol and/or water.

The solvent is typically present in the reactive solution in an amount of 90 to 99.99 wt % based on the total weight of the reactive solution. The solvent is preferably present in the reactive solution in an amount of 95 to 99.99 wt %, 98 to 99.90 wt %, or 99.50 to 99.85 wt % based on the total weight of the reactive solution.

In a method of disposing the coating on an inner surface of a first container, the reactive solution including dopamine-containing monomer, the buffer, solvent and any additional components are poured into the first container or into a reactor and typically subjected to a first agitation process. When the reactants are disposed into a first container, the first container is typically sealed with a lid and placed in a first agitator to facilitate the conversion of the dopamine-container monomer to polydopamine. While the agitation technique is not particularly limited, the agitator is preferably a roller on which the contents of the first container are agitated.

In this case, the first container undergoes rotation on the roller. The polydopamine produced by auto-polymerization of the dopamine-containing monomer coats the inner surface of the first container and the lid that seals the first container. The agitation is typically for a period of 2 hours to 96 hours, preferably 5 to 80 hours, and more preferably 10 to 30 hours at a temperature of 10 to 50° C., preferably 18 to 40° C.

As the auto-polymerization progresses, the solution appears to darken and an inner surface of the first container is coated with the polydopamine. The coating of the inner surface of the first container occurs during the auto-polymerization. When the coating of the inner surface of the first container is completed, the contents of the first container can be discharged to a second container from where some of the ingredients can be recycled if desired.

The first container is typically next rinsed, for example, by filling with de-ionized water and subjecting it to a second agitation process, typically for 30 minutes to 5 hours at a temperature of 10 to 50° C., preferably at room temperature, to remove any unreacted reactants (e.g., dopamine-containing monomer and/or buffer) and polydopamine that is not bonded to the coating. The polydopamine that is not bonded to the coating may include lower molecular weight reaction products. The second agitation process may involve sonication. After the second agitation process is completed, the deionized water is removed from the first container.

It is also envisioned that the reactive solution can be applied and the polydopamine coating formed by other techniques, for example, spraying over the interior surface of the container.

In another embodiment, the first container may be cleaned by spraying the inside of the first container with high pressure water to remove unreacted reactants and unbonded polydopamine.

The first container may then be optionally filled with an organic solvent and subjected to a third agitation step for a period of 30 minutes to 5 hours at a temperature of 10 to 50° C., preferably at room temperature, where any unreacted reactants or lower molecular weight products are removed from the first container. The organic solvent is preferably propylene glycol methyl ether acetate (PGMEA). The containers can then be blown dry using purified air or nitrogen.

The polydopamine coating on the inner surface of the container and the lid has an average thickness of 1 to 100 nanometers, preferably 5 to 50 nanometers. The use of multiple layer coatings of the polydopamine is also envisioned which may be useful, for example, where even thicker coatings are desired.

In an embodiment, the polydopamine may be prepared in a large batch reactor or in a continuous reactor by reacting together the reactants until the color of the reactant solution has begun to change. The change in color indicates that the auto-polymerization has begun. For example, it has been observed that the color changes to light orange and then begins to darken, eventually becoming black indicating that polymerization to a high molecular weight polydopamine has occurred. Before the auto-polymerization is completed, the reaction product is discharged into a plurality of containers, each of which is sealed with a lid and may be subjected to the first agitation process on a roller. The auto-polymerization process is completed in each container during the first agitation process and results in the formation of the polydopamine coating on an inner surface of each of the plurality of containers. The agitation may be conducted at a suitable temperature for a period of time that facilitates precipitation of the polydopamine from the solution on the inner surface of the containers.

After the coating of the inner surfaces is completed, the solution from the containers is removed and the containers may be subjected to one or more additional agitation processes, for example, the second and third agitation processes with water and optionally the solvent respectively to remove any traces of unreacted reactants and unbonded polydopamine thus leaving behind a stable coating on the inner surfaces of each of the containers and their respective lids.

In an embodiment, the polydopamine coating process may be enhanced by the addition of an oxidizing agent to the coating solution including the dopamine containing monomer, pH buffer, and solvent. The oxidizing agent is believed to accelerate the polymerization of dopamine, leading to greater deposition of polydopamine on the bottle surface. Oxidizing agents are preferably water soluble and include, for example, hydrogen peroxide, organic peroxides, nitrates, permanganates, periodates, persulfates, dichromates, chlorates, perborates, or a combination thereof. The oxidizing agent, if used, is typically present in the solution in an amount of 0.001 wt % to 10 wt % based on the total weight of the solution. More preferably, it is in an amount of 0.01 wt % to 5 wt %, from 0.05 to 0.1 wt % based on the total weight of the reactive solution.

In an embodiment, the polydopamine can be functionalized after polymerization to form a polydopamine derivative. Derivatized polydopamines may show improved effectiveness for removing metals from the contents of the container. Functionalizing agents that may be used to functionalize the polydopamine include, for example, primary amines, secondary amines, tertiary amines, moieties containing carboxylic acids that are functionalized with amines and/or thiols or a combination thereof. The amines may, for example, be linear or cyclic amines. Preferred amines are primary amines, secondary amines, or a combination thereof.

Examples of primary amines include methylamine, ethylamine, propylamine, ethylenediamine, monoethanolamine, and the like, or a combination thereof. Examples of secondary amines include dialkylamines such as dimethylamine, diethylamine, dipropylamine, dibutylamine, diethanolamine, and the like, or a combination thereof.

In an embodiment, amine-functionalized carboxylic acids may be used as functionalizing agents. The carboxylic acid present in these functionalizing agents facilitate additional metal removal capabilities compared with functionalizing agents that include only primary or secondary amines. Examples include aminopolycarboxylic acids (APCAs) such as iminodiacetic acid, aspartic acid, ethylenediaminetetraacetic acid, hyaluronic acid, and the like, or a combination thereof.

The polydopamine may be derivatized with functionalizing agents that comprise a thiol and a carboxylic acid. An example of a functionalizing agent that contains both thiol and carboxylic acid is mercaptosuccinic acid. Functionalizing agents that contain both thiol and amines may also be used to facilitate metal removal from the contents of the container.

In an embodiment, amine and/or thiol-containing functionalizing agents that comprise a sulfonic acid group may also be used to facilitate metal removal from the contents of the container. An example of such a functionalizing agent is sulfamic acid, 3-mercapto-1-propanesulfonic acid, or a combination thereof.

Derivatization of the polydopamine coating is preferably conducted after formation of the polydopamine coating. The functionalizing agent can be dissolved in a solvent prior to being added to a container that is coated with polydopamine. In another embodiment, the functionalizing agent may be added to the reactive solution prior to the formation of polydopamine on the inner surface of the container. The solvent is preferably water, an alcohol or a combination thereof. A preferred alcohol is ethanol. The preferred solvent is water. The container may be sealed with a lid and is typically subjected to rolling for a typical period of 2 to 48 hours, preferably 6 to 24 hours at a temperature of 10 to 50° C. The contents of the container are then discharged from the container and the container can be washed with water followed by a separate wash with a solvent (e.g., PGMEA) as detailed above. The container may then be dried, for example, using air or nitrogen.

In an embodiment, the functionalizing agent is present in the solution in an amount of 0.01 to 10 wt %, based on the total weight of the reactive solution. In another embodiment, the functionalizing agent is present in the solution in an amount of 0.05 to 0.50 wt %, based on the total weight of the reactive solution.

Derivatized polydopamine coatings can display a greater overall ability to extract ionic impurities from solutions contained in the container. In an embodiment, the derivatized polydopamine coatings can extract at least 5 wt % more, preferably at least 10 wt % more, and more preferably 15 wt % more ionic impurities than an underivatized polydopamine coating of the same thickness.

The polydopamine or derivatized polydopamine can form a continuous coating on an inner surface of the container (this includes the enclosure and optionally also includes the lid). As such, the coating may continuously contact the material within the container, leading to reduced impurity levels of the stored materials.

The polydopamine and the derivatized polydopamine coatings detailed herein along with the methods of manufacturing them are exemplified by the following non-limiting examples.

### EXAMPLES

### Example 1

This example was conducted to demonstrate the preparation of a polydopamine coating on a low density polyethylene (LDPE) container. 0.15 g of dopamine hydrochloride (Fisher Scientific), 0.06 g of tris buffer (tris(hydroxymethyl)aminomethane) (Fisher Scientific) and 50 mL of de-ionized (DI) water were added to a 60 milliliter (mL) LDPE container. The LDPE container is a bottle. The container was agitated on a roller for 3 days, during which time the solution was observed to gradually darken. After 3 days, the solution was discarded and an off-color polydopamine coating was observed on the inside of the container. The container was filled with fresh DI water and sonicated for 2 hours. The water was discarded and the container was filled with propylene glycol methyl ether acetate (PGMEA) and sonicated for a further 2 hours.

Two containers, one of which was a non-coated control and the other having a polydopamine coating on the inner surface, were then filled with PGMEA, which had been spiked with a custom multi-element standard (SCP Science) to give a solution that contains approximately 10 parts per billion (ppb) of each of the following metals: Al, Ca, Cr, Cu, Fe, Mg, Mn, Ni, K, Na, Sn, Ti, and Zn. The respective containers with their contents were shaken overnight. The following day, the contents of each container were analyzed for metals content using an Agilent 7700 Single Quadrupole inductively coupled plasma-mass spectrometer (ICP-MS). The results, in parts per billion (ppb), are shown below. The polydopamine coating appeared to have reduced the concentrations of Cu and Zn by over 90%, while substantial reductions in Al, Cr, Mn, Ni, and Sn also observed as may be seen in the Table 1.

TABLE 1

| Metal | Control (ppb) | Polydopamine coated (ppb) |
|---|---|---|
| Al | 11.855 | 8.640 |
| Ca | 15.445 | 12.725 |
| Cr | 13.585 | 10.640 |
| Cu | 12.075 | 0.955 |
| Fe | 15.385 | 8.400 |
| Mg | 12.835 | 10.235 |
| Mn | 12.275 | 6.725 |
| Ni | 12.635 | 5.050 |
| K | 14.285 | 14.875 |
| Na | 12.165 | 11.35 |
| Sn | 10.395 | 6.990 |
| Ti | 3.210 | 2.360 |
| Zn | 14.555 | 1.050 |

### Example 2

This example was conducted to determine if polydopamine coated containers contain any defects in the coating that is disposed on an inner surface of the container.

1.88 g of dopamine hydrochloride (Alfa Aesar) and 4.54 g of the tris buffer (tris(hydroxymethyl)aminomethane) (Fisher Scientific) were added to two glass gallon containers, along with 3750 milliliters of DI water. Both containers were filled with an equal amount of the reactants and were sealed with lids. Both containers were placed on a roller overnight (approximately 16 hours) and subjected to agitation by rolling. The following day, the contents were emptied from the containers. The containers were then manually washed 5 times with DI water to remove residual polydopamine solution. An uncoated control container was subjected to the same manual washing procedure.

The three containers were then cleaned and dried using an automated container washing apparatus, designed to prepare containers for packaging of high-purity chemicals. The containers were then filled with filtered PGMEA. To test the contents for film defects, the containers were plumbed into a dispense wafer track and spin-coated on virgin Si wafers, followed by a soft bake at 175° C. for 60 seconds. The wafers were then inspected for defects using a KLA Tencor Surfscan SP5 defect inspection tool. The inspection tool uses a laser to scan the wafer for any inhomogeneities down to a certain size threshold, which it then classifies as “defects”.

The defect count results are shown in the Table 2 below where it may be seen that the polydopamine coatings did not elevate the defect count.

TABLE 2

| Container | Defects (>19 nm) | Defects (>24 nm) |
|---|---|---|
| Control | 51 | 37 |
| Polydopamine coated #1 | 34 | 25 |
| Polydopamine coated #2 | 43 | 36 |

The three containers (from the Table 2) were then tested for metal impurity contents using an Agilent 8900 Triple Quadrupole ICP-MS. The metals results are shown in the Table 3 below (all results in ppb).

TABLE 3

| | Control | Polydopamine coated #1 | Polydopamine coated #2 |
|---|---|---|---|
| Metal | (ppb) | (ppb) | (ppb) |
| Na | 0.09 | 0.03 | 0.07 |
| Mg | 0.11 | 0.12 | 0.09 |
| Al | not detected | 0.01 | not detected |
| Ca | not detected | 0.11 | 0.14 |
| Cr | 0.12 | 0.11 | 0.11 |
| Mn | n.d. | not detected | not detected |
| Fe | 0.16 | 0.14 | 0.15 |
| Ni | 0.03 | 0.02 | 0.02 |
| Cu | 0.05 | 0.02 | 0.04 |
| Zn | 0.03 | 0.01 | 0.01 |
| As | 0.05 | 0.05 | 0.05 |
| Pb | 0.03 | not detected | not detected |

### Example 3

This example was conducted to demonstrate the efficacy of a derivatized polydopamine coating in removing metal impurities from a solution in the container. The polydopamine coating was derivatized with dimethylamine. A polydopamine coating and a derivatized polydopamine coating were each disposed on the inner surfaces of two separate containers. Both of the containers (one with the polydopamine coating and the other with the derivatized polydopamine coating) were evaluated for their abilities to remove ionic impurities from the contents of the containers.

The respective containers were coated as follows. 0.03 g of dopamine hydrochloride (Fisher Scientific), 0.07 g of tris buffer (tris(hydroxymethyl)aminomethane) (Fisher Scientific) and 60 mL of DI water were added to two 60 mL LDPE. The containers were agitated on a roller overnight, after which the contents were discarded and the containers were washed with DI water and blown dry with nitrogen. 0.76 g of 40 wt % dimethylamine (DMA) in water (Sigma Aldrich) and 59.37 g of DI water was then added to one of the containers. The container was placed back on the roller overnight, after which the contents were emptied and the container was washed and blown dry as detailed above.

Each of the containers were then filled with 60 g of PGMEA, which had been spiked with approximately 10 ppb per metal of the custom multi-element standard used in Example 1. They were then agitated (shaken) overnight. A non-coated control was also evaluated alongside the coated containers. The following day, the contents were analyzed for metals content using an Agilent 7700 Single Quadrupole inductively coupled plasma-mass spectrometer (ICP-MS). The results, in ppb, are shown below in Table 4.

TABLE 4

| Metal | Control | Polydopamine coated | Polydopamine + DMA |
|---|---|---|---|
| Al | 10.835 | 9.987 | 8.386 |
| Ca | 11.790 | 11.409 | 9.655 |
| Cr | 12.448 | 11.900 | 11.698 |
| Cu | 9.252 | 2.309 | 3.222 |
| Fe | 8.935 | 8.044 | 6.193 |
| Mg | 10.011 | 10.783 | 4.908 |
| Mn | 11.282 | 10.933 | 4.732 |
| Ni | 11.192 | 10.503 | 4.732 |
| K | 11.734 | 11.424 | 10.820 |
| Na | 11.549 | 11.249 | 10.785 |
| Sn | 6.443 | 6.100 | 5.420 |
| Ti | 3.699 | 2.950 | 3.142 |
| Zn | 11.237 | 8.109 | 4.717 |

### Example 4

This example was conducted to demonstrate the efficacy of an oxidizing agent in facilitating the removal of ionic impurities from the contents of a polydopamine coated container. One container had a polydopamine coating that contained an oxidizing agent during the formation of the polydopamine coating, while the other contained had a polydopamine coating that did not use the oxidizing agent during the formation of the polydopamine coating. Both polydopamine coatings were subsequently derivatized with dimethylamine.

The respective polydopamine coatings were formed on the inner surface of the containers as follows. 0.06 g of dopamine hydrochloride (Fisher Scientific) and 0.07 g of tris buffer (tris(hydroxymethyl)aminomethane) (Fisher Scientific) were added to two 60 mL LDPE bottles. To one container was added 60 mL of DI water; to the other container was added 60 mL of DI water containing 7 mg of dissolved sodium metaperiodate (the oxidizing agent, Fisher Scientific). The containers were agitated on a roller overnight, after which the contents were discarded and the containers were washed with DI water and blown dry with nitrogen.

0.30 g of 40 wt % dimethylamine (DMA) in water (Sigma Aldrich) and 60 mL of DI water was then added to both of the containers. The containers were placed back on the roller and agitated overnight, after which the contents were discarded and the containers were washed and blown dry as detailed above.

The polydopamine coated containers along with one non-coated control container were then filled with 60 g of PGMEA, which had been spiked with approximately 10 ppb per metal of the custom multi-element standard used in Example 1. They were then agitated (shaken) overnight. The following day, the contents were analyzed for metals content using an Agilent 7700 Single Quadrupole inductively coupled plasma-mass spectrometer (ICP-MS). The results, in ppb, are shown below in Table 5.

TABLE 5

| Metal | Control | Without oxidizing agent | With oxidizing agent |
|---|---|---|---|
| Al | 10.756 | 10.163 | 9.579 |
| Ca | 11.711 | 8.942 | 8.740 |
| Cr | 12.030 | 11.679 | 11.277 |
| Cu | 10.796 | 3.271 | 1.923 |
| Fe | 10.552 | 9.739 | 9.300 |
| Mg | 10.442 | 6.189 | 4.835 |
| Mn | 11.226 | 4.254 | 3.256 |
| Ni | 11.661 | 7.231 | 5.774 |
| K | 11.201 | 11.071 | 10.448 |
| Na | 10.846 | 11.121 | 10.463 |
| Sn | 5.880 | 6.174 | 6.108 |
| Ti | 3.267 | 3.985 | 4.370 |
| Zn | 9.887 | 3.601 | 2.792 |

1. A container comprising:
an enclosure having an outer surface and an inner surface; and
a polydopamine coating that is optionally derivatized disposed on an inner surface of the enclosure.

2. The container of claim 1, wherein the enclosure comprises a metal, a glass, or a polymer.

3. The container of claim 1, wherein the polydopamine coating is derivatized.

4. The container of claim 3, wherein the polydopamine coating is derivatized with an amine, a thiol, a carboxylic acid or a combination thereof.

5. The container of claim 4, wherein the amine is a dimethylamine.

6. The container of claim 1, where the polydopamine coating has a thickness of 1 to 100 nanometers.

7. The container of claim 1, wherein the container contains a chemical composition in contact with the polydopamine coating.

8. The container of claim 7, wherein the chemical composition comprises an organic solvent.

9. The container of claim 1, wherein the container further comprising a cap for sealing the enclosure.

10. A method of coating a container, comprising:
(a) providing a container comprising an enclosure having an outer surface and an inner surface; and
(b) disposing a solution comprising dopamine hydrochloride, a buffer and a solvent in the container.

11. The method of claim 10, wherein the solution further comprises an oxidizing agent.
